(19) United States
(12) Patent Application Publication
(10) Pub. No.: US 2024/0257660 A1
(43) Pub. Date: Aug. 1, 2024

(54) MUSIC THEORY EDUCATIONAL TOY SYSTEM AND METHOD OF USE THEREOF

(71) Applicant: Rachel Kantrowitz, Burlington, VT (US)

(72) Inventor: Rachel Kantrowitz, Burlington, VT (US)

(21) Appl. No.: 18/428,029

(22) Filed: Jan. 31, 2024

Related U.S. Application Data
(60) Provisional application No. 63/442,249, filed on Jan. 31, 2023.

(51) Int. Cl. G09B 15/02; G09B 1/10; G09B 15/00

(52) U.S. Cl. CPC G09B 15/023; G09B 1/10; G09B 15/002

(57) ABSTRACT

A method for teaching music theory is provided. The method includes providing a set of blocks, each block of the set associated with a musical note. The arranging of the blocks in an allowed sequence forms a musical composition, where each of the blocks are keyed so as to only allow combinations that produce actual chords. A system for teaching music theory is also provided. The system includes a set of blocks, each block of the set associated with a musical note, where each of the blocks are keyed so as to only allow combinations that produce actual chords. The system further includes a base unit for placement of the set of blocks, where the base unit provides audio via a speaker and visual information on a display based on the arrangement of the set of blocks placed in a slot of the base unit.

### RELATED APPLICATIONS

This application claims priority benefit of U.S. Provisional Application Ser. No. 63/442,249 filed 31 Jan. 2023, the contents of which are hereby incorporated by reference.

### FIELD OF THE INVENTION

The present invention in general relates to the field of music and in particular to a music theory educational toy.

### BACKGROUND OF THE INVENTION

The written composition of music uses notes for the representation of musical sounds. Notes are the visual building blocks for musical performance, comprehension, and analysis of sound reproduction. Notes signify the fundamental frequencies in a musical composition. The fundamental, is defined as the lowest frequency of a periodic waveform. In music, the fundamental is the musical pitch of a note that is perceived as the lowest partial present. In terms of a superposition of sinusoids, the fundamental frequency is the lowest frequency sinusoidal in the sum of harmonically related frequencies, or the frequency of the difference between adjacent frequencies. The fundamental being the lowest frequency is also perceived as the loudest that the ear identifies as the specific pitch of the musical tone of a harmonic spectrum. Two notes with fundamental frequencies in a ratio equal to any integer power of two (e.g., half, twice, or four times) are perceived as very similar. Because of that, all notes with these kinds of relations can be grouped under the same pitch class.

In English and Dutch speaking regions, pitch classes are typically represented by the first seven letters of the Latin alphabet (A, B, C, D, E, F and G). The eighth note, or octave, is given the same name as the first, but has double its frequency (first harmonic). The name octave is also used to indicate the span between a note and another with double frequency.

While the study of music and the related theory is quite complex, children often show an appreciation and an ability for music at an early age. Thus, there exists a need for innovative systems and methods to teach music composition and musical notes to children.

### SUMMARY OF THE INVENTION

A method for teaching music theory is provide. The method includes providing a set of blocks, each block of the set associated with a musical note. The arranging of the blocks in an allowed sequence forms a musical composition, where each of the blocks are keyed so as to only allow combinations that produce actual chords.

A system for teaching music theory is provided, The system incudes a set of blocks, each block of the set associated with a musical note, where each of the blocks are keyed so as to only allow combinations that produce actual chords. The system further includes a base unit for placement of the set of blocks, where the base unit provides audio via a speaker and visual information on a display based on the arrangement of the set of blocks placed in a slot of the base unit.

### BRIEF DESCRIPTION OF THE DRAWINGS

The present invention is further detailed with respect to the following drawings. These figures are not intended to limit the scope of the present invention but rather illustrate certain attributes thereof.

FIG. 1 illustrates the representative blocks that have keyed shapes for compatible music notes that may be arranged and combined to create a musical composition in accordance with embodiments of the invention;

FIG. 2 illustrates a portion of the note blocks with their corresponding keyed shapes and receiving cavities according to an embodiment of the invention;

FIG. 3 illustrates seven blocks representative of the notes A, B, C, D, E, F and G for implementing embodiments of the invention;

FIG. 4 illustrates a block with indicia and an RFID chip for scanning with a portable computing device for interaction with an App in accordance with embodiments of the invention;

FIG. 5 illustrates a user interface of an App displayed on a portable communication and computing device in accordance with embodiments of the invention;

FIG. 6 illustrates a base unit for placement of the note blocks that provides audio and visual information based on the arrangement of the note blocks in accordance with embodiments of the invention;

FIG. 7 illustrates a set of charts for the simplification of teaching musical arrangement for college level academic study in accordance with embodiments of the invention;

FIG. 8 illustrates an expansion pack of fifteen different keys that includes seven flats and 7 sharps for use with the base set with seven notes of embodiments of the invention;

FIG. 9 is a graphic that summarizes the use and relationship to basic music creation and the note blocks;

FIG. 10 is a teaching graphic showing how fifty songs, including many well known songs from popular artists, have the same four chords;

FIG. 11 is a graphic that explains how a user may scan the note blocks with a camera to interact with an App to compose songs;

FIG. 12 is a graphic indicating the use of the blocks as a non-screen based alternative to teaching music;

FIG. 13 is a graphic showing the ability to simplify advanced music theory for college level instruction with embodiments of the invention; and

FIG. 14 is a graphic explaining the potential of the expansion pack as shown in FIG. 8.

### DESCRIPTION OF THE INVENTION

The present invention has utility as a method and system for the simplified teaching of music theory to children and adults who are novices in music. In a specific inventive embodiment, a set of seven blocks are provided, one block for each note in the key of C Major. The blocks are designed with interlocking shapes that only fit together in a way that spells chords easily for both kids and adults starting to learn music. In embodiments of the invention, each of the seven blocks has a letter on the front and a corresponding solfege symbol, numeral, and staff note on the other faces of the block. In an embodiment, a set of seven sharps and seven flats are provided as an expansion pack so that every possible chord combination is available. In an embodiment an application (App) is provided that scans the blocks to provide further interactive musical lessons that includes audible sounds based on the order combination of the notes shown on the blocks. In an embodiment a base unit that interacts with the arranged blocks is also provided.

It is appreciated that while the embodiment illustrated and disclosed herein is based on seven notes for English and Dutch speaking regions, embodiments of the invention may be adapted for other regions and languages illustratively including Europe using the solfège naming convention do-re-mi-fa-sol-la-si, Byzantium using the names Pa-Vu-Ga-Di-Ke-Zo-Ni (Πα-Boυ-Γα-Δι-Kε-Zω-Nη), and traditional Indian music svaras notes that are commonly represented with the seven notes, Sa, Re, Ga, Ma, Pa, Dha and Ni.

It is to be understood that in instances where a range of values are provided that the range is intended to encompass not only the end point values of the range but also intermediate values of the range as explicitly being included within the range and varying by the last significant figure of the range. By way of example, a recited range of from 1 to 4 is intended to include 1-2, 1-3, 2-4, 3-4, and 1-4.

Unless otherwise defined, all technical and scientific terms used herein have the same meaning as commonly understood by one of ordinary skill in the art to which this invention belongs. The terminology used in the description of the invention herein is for the purpose of describing particular embodiments only and is not intended to be limiting of the invention.

Unless indicated otherwise, explicitly or by context, the following terms are used herein as set forth below.

As used in the description of the invention and the appended claims, the singular forms “a,” “an” and “the” are intended to include the plural forms as well, unless the context clearly indicates otherwise.

Also as used herein, “and/or” refers to and encompasses any and all possible combinations of one or more of the associated listed items, as well as the lack of combinations when interpreted in the alternative (“or”).

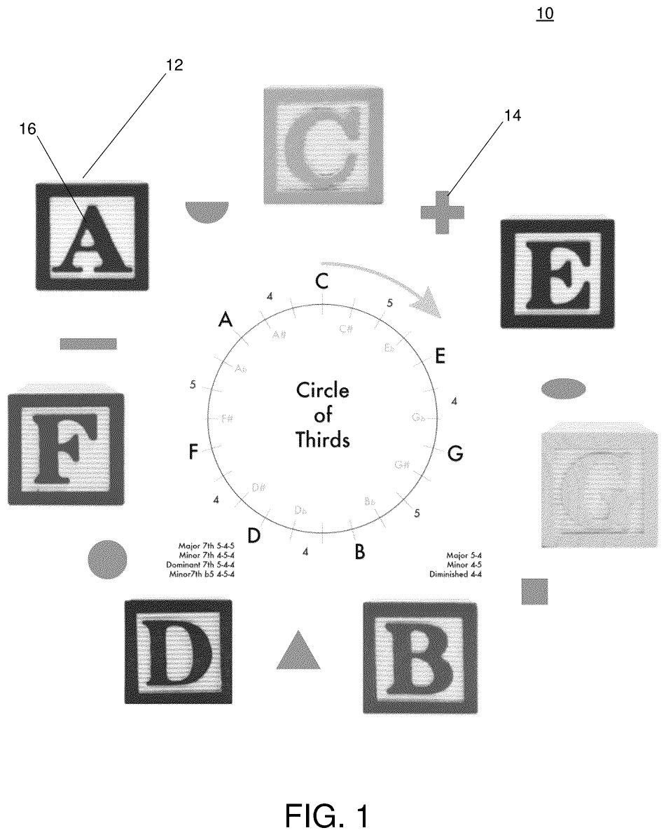

Referring now to the figures, FIG. 1 illustrates a set 10 representative blocks 12 that have keyed shapes 14 for compatible music notes 16 that may be arranged and combined to create a musical composition. The keyed shapes 14 provide feedback to the student of what notes may or may not be able to be combined with each other. As shown the note blocks 12 are displayed based on the “Circle of Thirds” which is a visual tool used to remember the order of thirds in a scale and therefore the notes of the chords in any given major or minor scale.

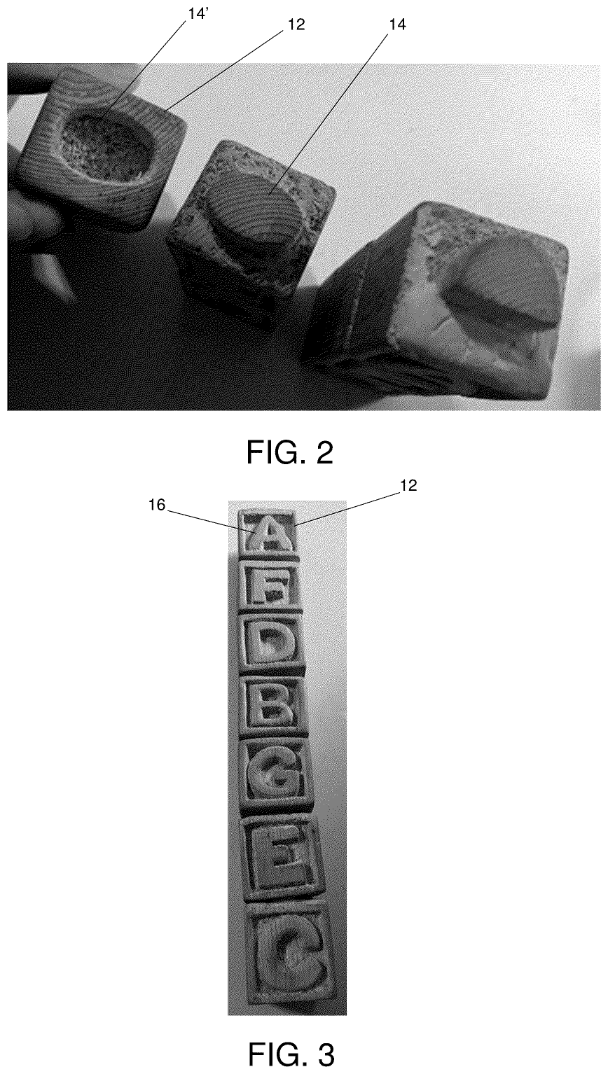

FIG. 2 illustrates a portion of the note blocks 12 with their corresponding keyed shapes 14 that emerge from the block 12 and receiving cavities 14′ within the block 12. The note blocks 12 may be formed from wood, plastic, or metal, or a combination thereof.

FIG. 3 illustrates seven blocks representative of the notes A, B, C, D, E, F and G for the key of C Major. As shown the blocks have raised letters, which is an advantage for use with sight impaired individuals.

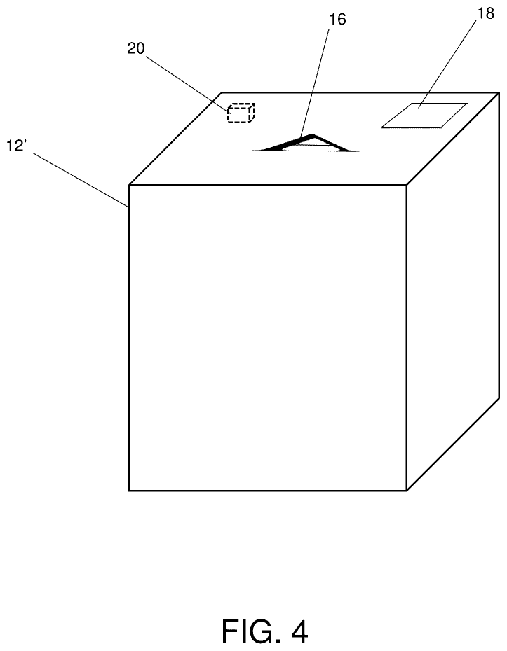

FIG. 4 illustrates a note block 12′ with a note 16 printed on the top face. The note block 12′ may have at least one of an indicia 18 or a radio frequency identification (RFID) chip 20 for scanning with a portable computing device for interaction with an App. The indicia 18 may be a barcode or other machine-readable identifier that may be scanned with a camera to uniquely identify a note 16 on the block 12.

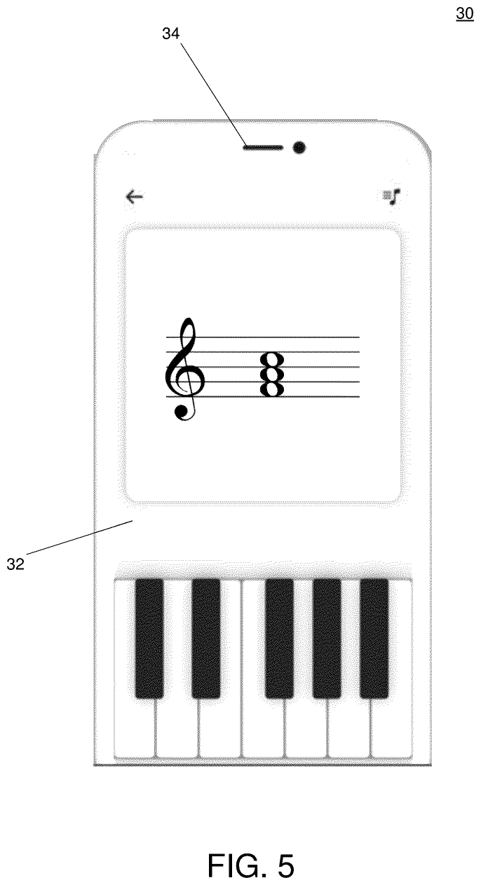

FIG. 5 illustrates a graphical user interface (GUI) of an application (App) displayed on a display 32 of a portable communication and computing device 30. The device 30 may be a cellular phone (as shown), a tablet, or a handheld computer. The device 30 may have connectivity to a remote server via Internet access provided via WiFi or a cellular network connection. The App provides information about the notes 16 as read from the blocks 12. A camera may be used to scan the note letter 16 of a block 12 itself using optical character recognition, or a machine-readable indicia 18 on the block 12. In specific embodiments the device 30 may have near field communication abilities in order to read an embedded RFID chip 20 in the block 12′ of FIG. 4.

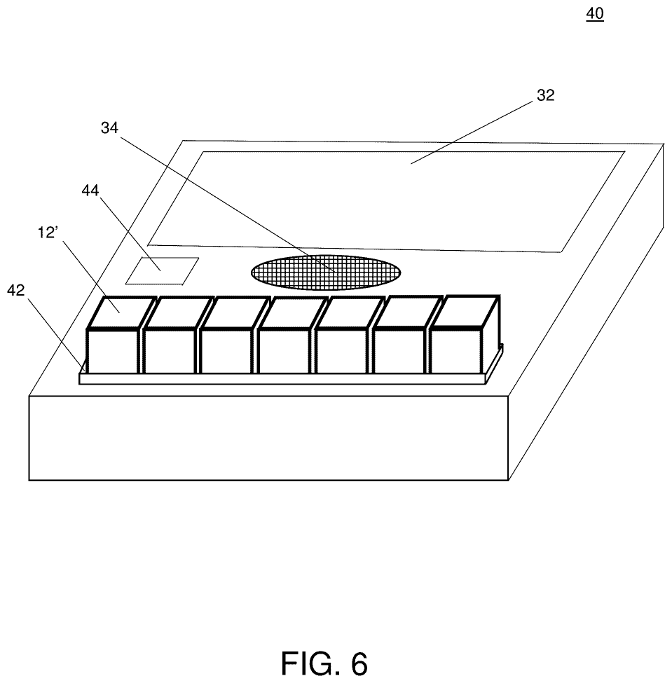

FIG. 6 illustrates a base unit 40 for placement of the note blocks 12 that provides audio via speaker 34 and visual information on display 32 based on the arrangement of the note blocks 12′ in a slot 42. The base unit 40 may have the ability to identify each note block 12′ based on an embedded RFID chip 20, indicia reader, character recognition, or manually inputted via the GUI on the display 32. All controls may be menu driven on the display that may be a touchscreen or via controls 44 that may be buttons, switches, or dials.

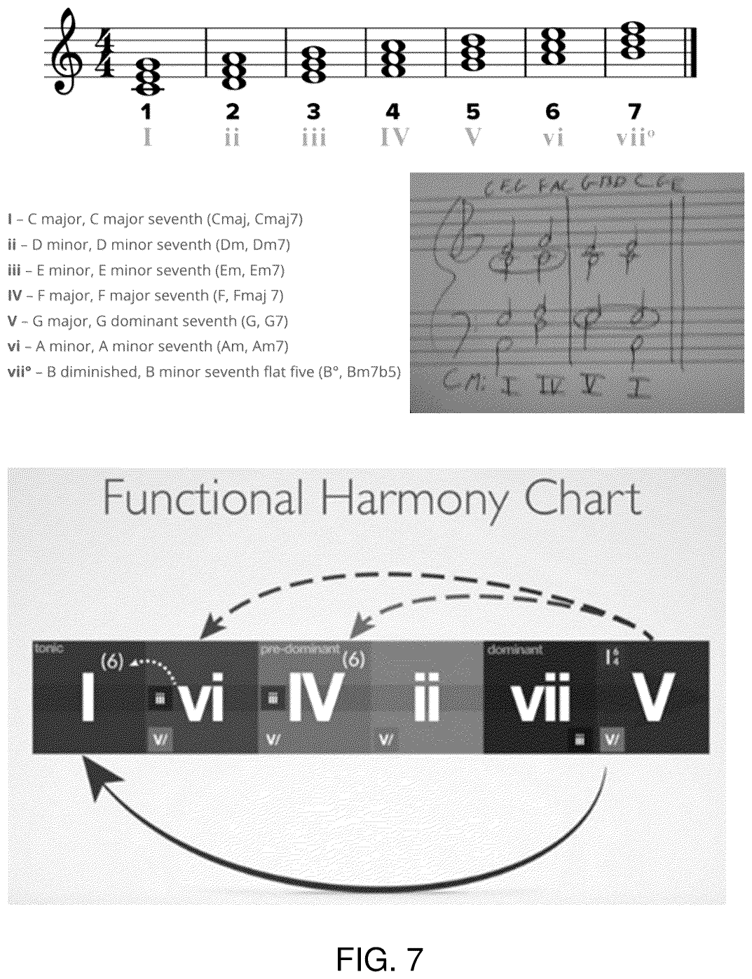

FIG. 7 illustrates a set of charts for the simplification of teaching musical arrangement for college level academic study using a function harmony chart.

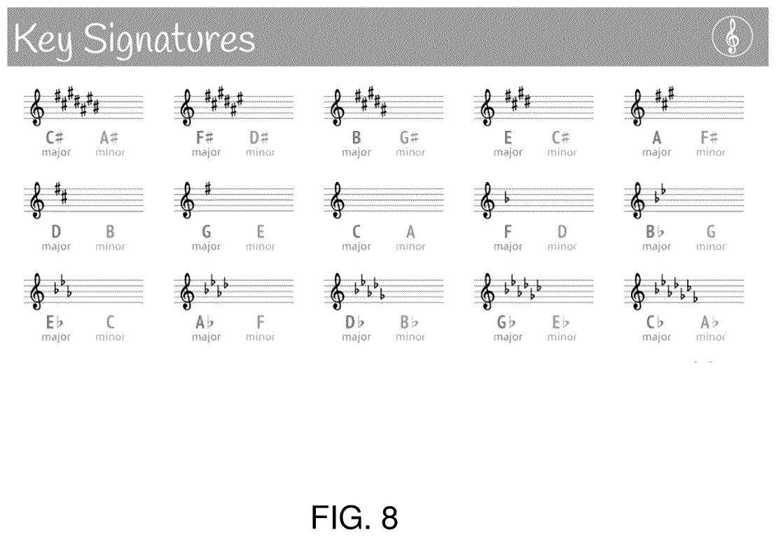

FIG. 8 illustrates an expansion pack of fifteen different keys that includes seven flats and 7 sharps for use with the base set 10 with seven notes so that every possible chord combination is available.

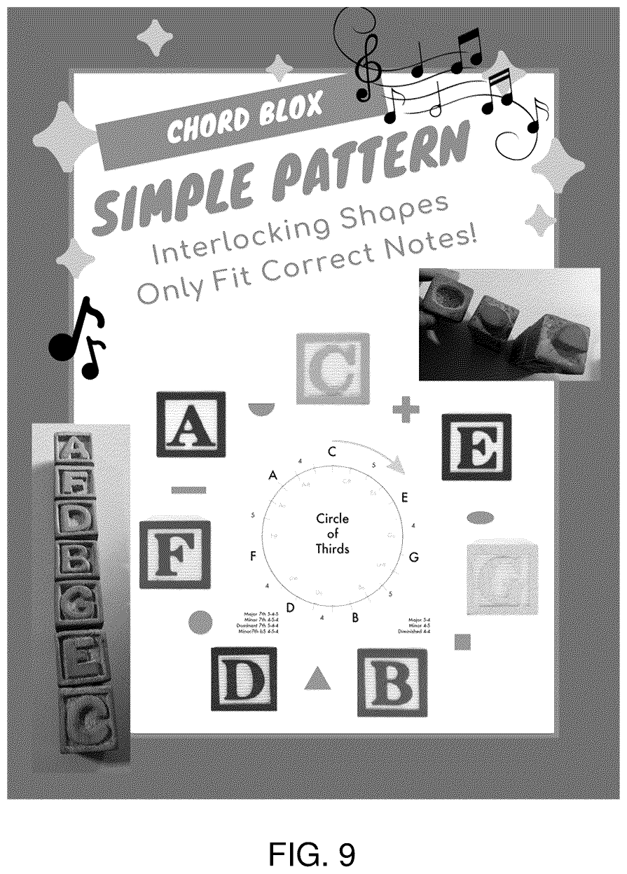

FIG. 9 is a graphic that summarizes the use and relationship to basic music creation of the note blocks.

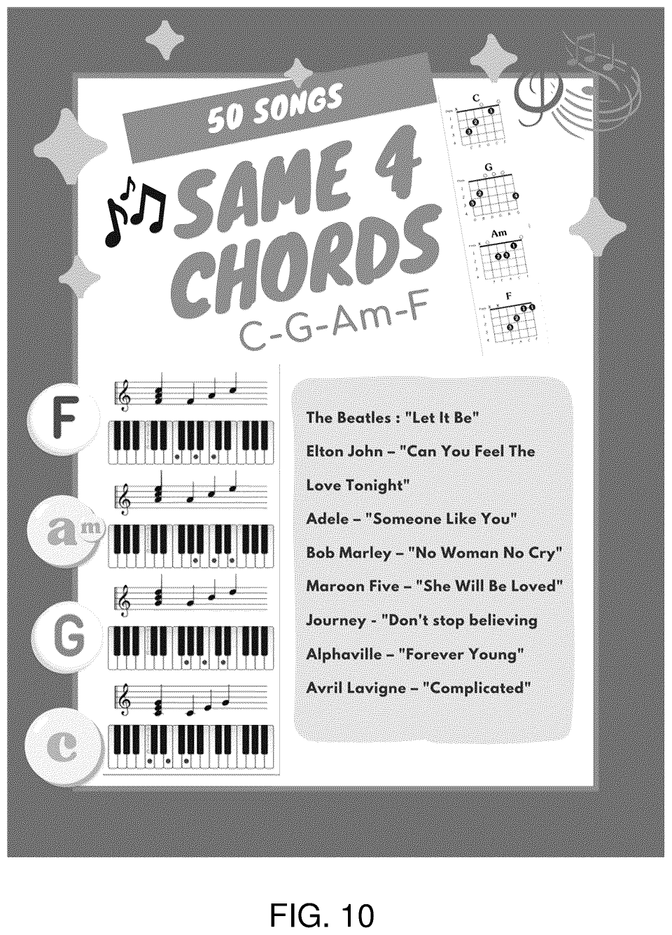

FIG. 10 is a teaching graphic showing how fifty songs, including many well known songs from popular artists, have the same four chords.

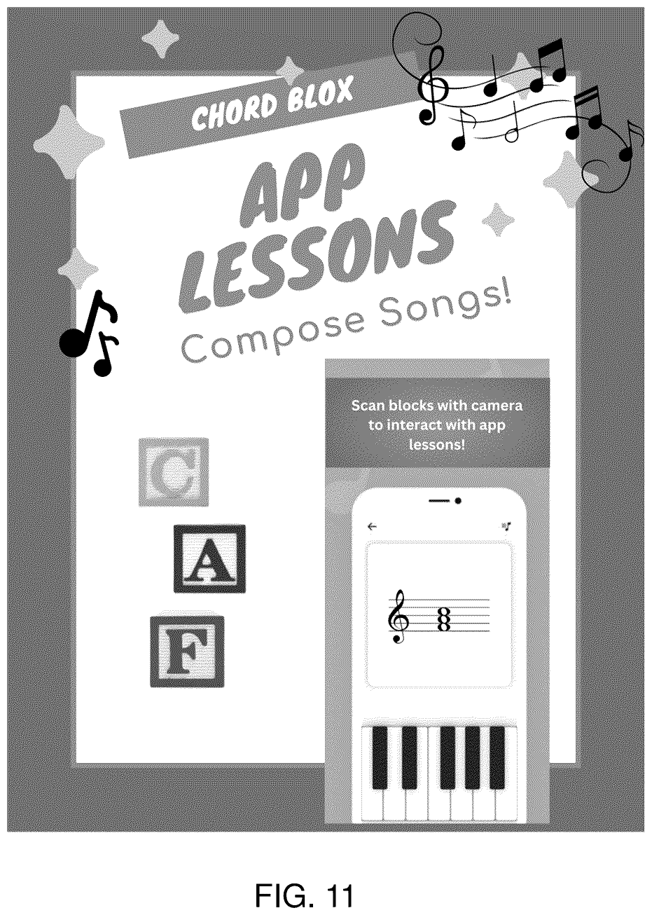

FIG. 11 is a graphic that explains how a user may scan the note blocks with a camera to interact with an App to compose songs.

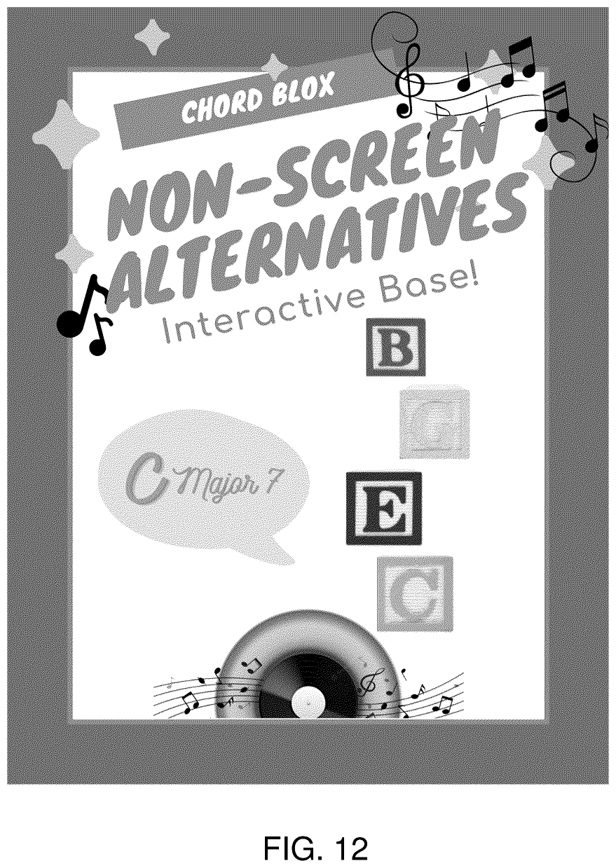

FIG. 12 is a graphic indicating the use of the blocks as a non-screen based alternative to teaching music.

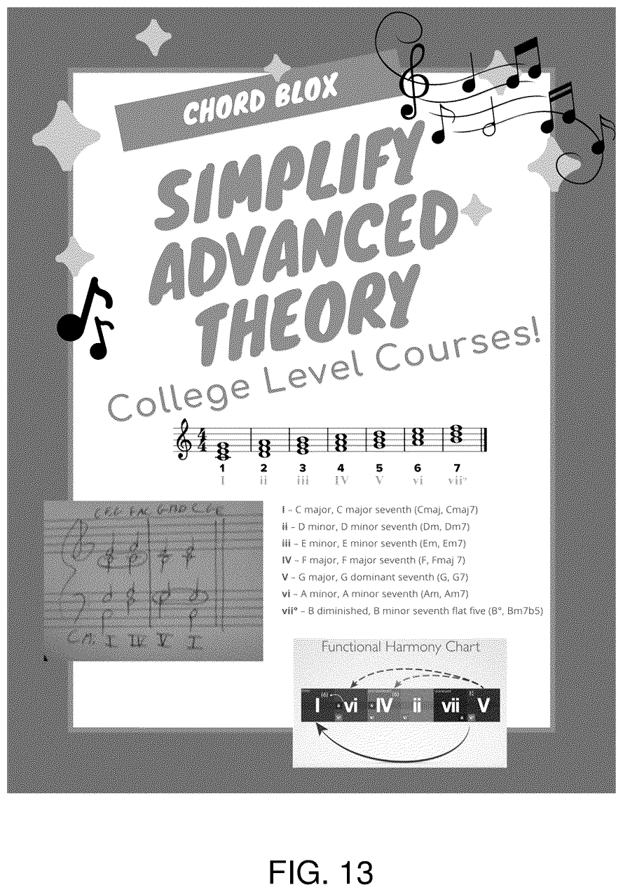

FIG. 13 is a graphic showing the ability to simplify advanced music theory for college level instruction with embodiments of the invention.

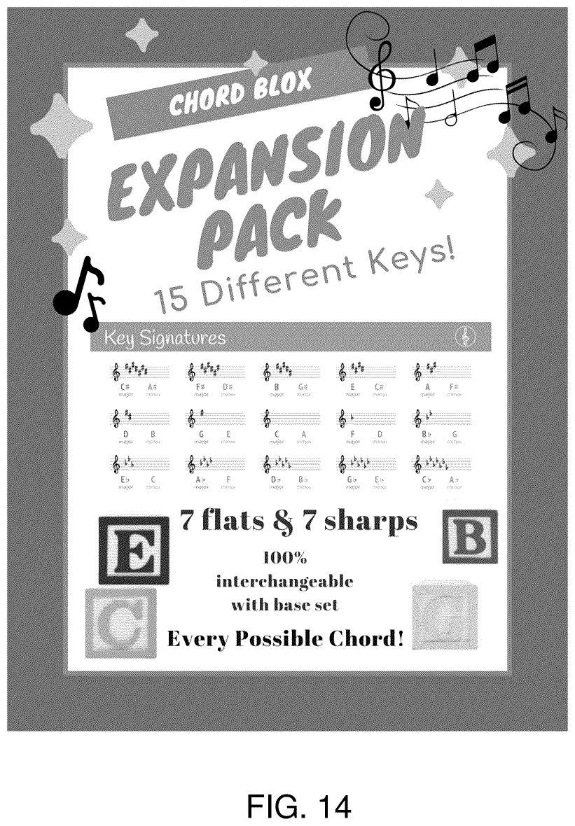

FIG. 14 is a graphic explaining the potential of the expansion pack as shown in FIG. 8.

The foregoing description is illustrative of particular embodiments of the invention, but is not meant to be a limitation upon the practice thereof. The following claims, including all equivalents thereof, are intended to define the scope of the invention.

1. A method for teaching music theory, the method comprising:
providing a set of blocks, each block of the set associated with a musical note; and
arranging the blocks in an allowed sequence to form a musical composition, where each of the blocks are keyed so as to only allow combinations that produce actual chords.

2. The method of claim 1 wherein the set contains seven blocks, one block for each note in a key of C Major.

3. The method of claim 1 wherein each block of the set of blocks has a letter on a front or upper face and a corresponding solfege symbol, numeral, and staff note on other faces of each of the blocks.

4. The method of claim 1 wherein the blocks are configured for use with a mobile computing and communication device.

5. The method of claim 1 wherein the blocks in the set are adapted for the regions and languages where they are used.

6. The method of claim 1 wherein the set of blocks are formed from wood, plastic, metal, or a combination thereof.

7. The method of claim 1 wherein each of the blocks has a keyed shape that emerges from the block and a receiving cavity within the block.

8. The method of claim 1 wherein each of the blocks further comprises at least one of an indicia or a radio frequency identification (RFID) chip for scanning with a portable computing device for interaction with an App.

9. The method of claim 8 wherein the indicia is a barcode or other machine-readable identifier.

10. The method of claim 1 further comprising providing a set of seven sharps and seven flats.

11. A system for teaching music theory, the system comprising:
a set of blocks, each block of the set associated with a musical note, where each of the blocks are keyed so as to only allow combinations that produce actual chords.

12. The system of claim 11 wherein the set contains seven blocks, one block for each note in a key of C Major.

13. The system of claim 11 wherein each block of the set of blocks has a letter on a front or upper face and a corresponding solfege symbol, numeral, and staff note on other faces of each of the blocks.

14. The system of claim 11 wherein the blocks are configured for use with a mobile computing and communication device.

15. The system of claim 11 wherein the blocks in the set are adapted for the regions and languages where they are used.

16. The system of claim 11 wherein the set of blocks are formed from wood, plastic, metal, or a combination thereof.

17. The system of claim 11 wherein each of the blocks has a keyed shape that emerges from the block and a receiving cavity within the block.

18. The system of claim 11 wherein each of blocks further comprises at least one of an indicia or a radio frequency identification (RFID) chip for scanning with a portable computing device for interaction with an App.

19. The system of claim 18 wherein the indicia is a barcode or other machine-readable identifier.

20. The system of claim 11 further comprising a base unit for placement of the set of blocks, where the base unit provides audio via a speaker and visual information on a display based on the arrangement of the set of blocks placed in a slot of the base unit.
